(19) United States
(12) Patent Application Publication
(10) Pub. No.: US 2025/0143434 A1
(43) Pub. Date: May 8, 2025

(54) Hair Cutter Having Magnetic Drive Assembly

(71) Applicant: Andis Company, Sturtevant, WI (US)

(72) Inventor: Trevor King, St. Francis, WI (US)

(21) Appl. No.: 18/937,715

(22) Filed: Nov. 5, 2024

Related U.S. Application Data
(63) Continuation of application No. PCT/US2024/054383, filed on Nov. 4, 2024.
(60) Provisional application No. 63/596,423, filed on Nov. 6, 2023.

(51) Int. Cl. A45D 26/00; A45D 24/36

(52) U.S. Cl. CPC A45D 26/0038; A45D 24/36

(57) ABSTRACT

A hair cutting device is provided with a magnetic drive assembly. The hair cutting device includes a cutting blade, a stationary blade and a magnetic drive assembly including a drive shaft coupled to a magnet and a bracket or yoke attached to the cutting blade. The bracket includes one or more magnets positioned on opposing sides of the drive shaft. The one or more magnets of the bracket and the magnet coupled to the drive shaft create an attractive and/or repulsive force between the magnet and the bracket generating linear movement of the bracket.

### CROSS-REFERENCE TO RELATED PATENT APPLICATIONS

The present application is a continuation of International Application No. PCT/US2024/054383, filed Nov. 4, 2024, which claims the benefit of and priority to U.S. Provisional Application No. 63/596,423 filed on Nov. 6, 2023, each of which is incorporated herein by reference in its entirety.

### BACKGROUND OF THE INVENTION

The present invention relates generally to the field of hair cutting devices, such as hair clippers or hair trimmers. The present invention relates specifically to a drive assembly for a hair cutting device that transfers rotational motion into side to side straight line motion of the blade assembly and has improved wear characteristics.

### SUMMARY OF THE INVENTION

One embodiment of the invention relates to a haircutter. The haircutter includes a housing extending along a longitudinal axis and a motor positioned within the housing. The haircutter further includes power source. The power source is configured to selectively distribute energy to the motor. The haircutter includes a drive assembly. The drive assembly includes a drive shaft coupled to the motor and a yoke. The yoke includes a body with a first side wall and a second side wall. The first side wall and the second side wall are positioned on opposing sides of the drive shaft. The yoke further includes a first yoke magnet positioned on the first side wall and a second yoke magnet positioned on the second side wall. The haircutter includes a magnet coupled to the drive shaft. The magnet generates a driving force. The haircutter further includes a blade assembly including a stationary lower blade and an upper blade supported relative to the stationary lower blade and coupled to the drive assembly. The drive assembly uses the energy from the power source to move the magnet relative to the yoke such that the upper blade moves over the stationary lower blade.

Another embodiment of the invention relates to a magnetic drive assembly for a haircutter. The magnetic drive assembly includes a drive shaft positioned along an axis of rotation and a bracket. The bracket includes a body, a first side wall, and a second side wall. The first side wall and the second side wall are positioned on opposing sides of the drive shaft. The bracket further includes a first magnet positioned on the first side wall and a second magnet positioned on the second side wall. The magnetic drive assembly further includes a drive magnet coupled to the drive shaft. The drive magnet generates a driving force to move the bracket.

Another embodiment of the invention relates to a magnetic drive assembly for a haircutter. The magnetic drive includes a drive shaft extending along an axis of rotation and a bracket. The bracket includes a body, a first side wall, and a second side wall. The first side wall and the second side wall are positioned on opposing sides of the drive shaft. The bracket further includes a first magnet positioned on the first side wall and a second magnet positioned on the second side wall. The magnetic drive assembly further includes a drive magnet coupled to the drive shaft. The drive magnet generates a driving force to move the yoke.

In a specific embodiment, the magnetic drive assembly further includes a retainer. In specific embodiments, the retainer is positioned behind the yoke and below the drive shaft such that the magnet extends over the retainer. The retainer includes a first projection and a second projection. The first projection and the second projection facing toward the first side wall and the second side wall of the yoke respectively. A first end magnet is positioned on the first projection and a second end magnet positioned on the second projection. The first end magnet faces the first magnet and the second end magnet faces the second magnet. The first end magnet and the second end magnet generate a controlling force to provide resistance against linear movement of the yoke.

Additional features and advantages will be set forth in the detailed description which follows, and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments. In addition, alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a detailed perspective view of a magnetic drive assembly for a hair cutting device, according to an exemplary embodiment.

FIG. 2 is a front view of the hair cutting device and magnetic drive assembly of FIG. 1, according to an exemplary embodiment.

FIG. 3 is a partially exploded view of the hair cutting device and magnetic drive assembly of FIG. 2, according to an exemplary embodiment.

FIG. 4 is a diagram of the magnetic drive assembly of FIG. 1, according to an exemplary embodiment.

FIG. 5 is a front view of a hair cutting device and a magnetic drive assembly, according to another exemplary embodiment.

FIG. 6 is a diagram of the magnetic drive assembly of FIG. 5, according to an exemplary embodiment.

FIG. 7 is a front view of a hair cutting device and a magnetic drive assembly, according to another exemplary embodiment.

FIG. 8 is a detailed perspective view of a magnetic drive assembly for the hair cutting device of FIG. 7, according to an exemplary embodiment.

FIG. 9 is a side view of the magnetic drive assembly of FIG. 7, according to an exemplary embodiment.

FIG. 10 is a detailed perspective view from above of the magnetic drive assembly of FIG. 9, according to an exemplary embodiment.

FIG. 11 is an exploded view of the magnetic drive assembly of FIG. 9, according to an exemplary embodiment.

FIG. 12 is a detailed perspective view of a magnetic drive assembly for a hair cutting device, according to another exemplary embodiment.

FIG. 13 is a diagram of the magnetic drive assembly of FIG. 12, according to an exemplary embodiment.

FIG. 14 is a perspective view of a hair cutting device and magnetic drive assembly, according to another exemplary embodiment.

FIG. 15 is a front view of the hair cutting device and magnetic drive assembly of FIG. 14, according to an exemplary embodiment.

FIG. 16 is a cross-sectional view taken along line 16-16 of FIG. 15, according to an exemplary embodiment.

FIG. 17 is a front view of the hair cutting device and magnetic drive assembly of FIG. 14 with a bracket removed, according to an exemplary embodiment.

FIG. 18 is a partially exploded view of the hair cutting device and magnetic drive assembly of FIG. 14, according to an exemplary embodiment.

FIG. 19 is a perspective view of the bracket of the magnetic drive assembly, according to an exemplary embodiment.

FIG. 20 is a rear perspective view of the bracket of FIG. 19, according to an exemplary embodiment.

FIG. 21 is a detailed perspective view of the magnetic drive assembly of FIG. 14 with the bracket removed, according to an exemplary embodiment.

FIG. 22 is a detailed perspective view of the magnetic drive assembly of FIG. 14 from above, according to an exemplary embodiment.

FIG. 23 is a perspective view of a blade assembly, according to an exemplary embodiment.

FIG. 24 is an exploded view of the blade assembly of FIG. 23, according to an exemplary embodiment.

FIG. 25 is a front perspective view of an upper blade of the blade assembly of FIG. 23, according to an exemplary embodiment.

FIG. 26 is a rear perspective view of the upper blade of FIG. 25, according to an exemplary embodiment.

FIG. 27 is a perspective view of a hair cutting device and magnetic drive assembly, according to another exemplary embodiment.

FIG. 28 is a perspective view of the hair cutting device of FIG. 27 with a bracket removed, according to an exemplary embodiment.

FIG. 29 is a cross-sectional view taken along line 29-29 of FIG. 27, according to an exemplary embodiment.

### DETAILED DESCRIPTION

Referring generally to the figures, various embodiments of a hair cutting device are shown. The hair cutting device includes a blade assembly with an upper or cutting blade supported relative to a lower or stationary blade such that the cutting blade is moveable (i.e., oscillates, reciprocates) relative to the stationary blade. As will be generally understood, drive assemblies are used to transfer rotational motion or movement of a motor into the reciprocating or side-to-side movement of the cutting blade. In conventional drive assemblies there is an eccentric drive or offset pin that engages a slot within a yoke. The yoke is coupled to the cutting blade and transfers the rotational motion of the drive into linear, side-to side motion. Traditional drive assemblies include friction from contact between the drive assembly components and the friction causes wear on the eccentric drive and/or yoke.

Applicant has found that using a magnetic drive assembly and/or a magnetic force to drive the motion of the cutting blade relative to the stationary blades allows the blades to effectively cut hair while also reducing and/or eliminating friction of the drive assembly and improving wear characteristics. The lack of and/or reduction of contact between a yoke and the pin of the drive assembly reduces friction and wear on components compared to the levels of friction and wear found in traditional blade assemblies. Applicant believes the reduction in friction reduces load on the motor and improves overall efficiency of the system for the various drive assembly designs discussed herein.

As previously noted, the magnetic drive assembly reduces friction specifically by eliminating the eccentric drive interaction or contact with the yoke. Applicant has found this reduction in friction reduces the torque required from the motor and can further be seen in improved or increased run-time in the hair cutting devices. In various embodiments of the drive assembly, a magnet, such as a ring magnet is coupled to a drive shaft while magnets are positioned on the yoke adjacent to the magnet coupled to the drive shaft. In a specific embodiment, where the magnet is a ring magnet and has polarized halves (i.e., positive pole is adjacent to one side of the yoke, negative pole adjacent to opposing side of yoke), the magnets on the yoke will be attracted to or repulsed by the adjacent portion of the ring magnet. In other words, as the ring magnet rotates with the drive shaft, the magnet forces will alternate pushing the yoke and the cutting blade linearly, side-to-side relative to the stationary blade depending on the attraction or repulsion between the yoke magnets and the ring magnet on the drive.

In various embodiments, the magnet coupled to the drive shaft is a solid disc magnet. In such an embodiment, the disc magnet is positioned coaxially with the drive shaft. In such an embodiment the magnet is diametrically polarized.

In various specific embodiments, the drive assembly further includes additional magnets positioned distal and/or outside relative to the yoke magnets. Applicant has found positioning the additional magnets distally provides an end stop that prevents the yoke from moving farther linearly than desired to either side. In other words, the additional end stop magnets provide for increased control of the yoke movement. Applicant believes the use of the end magnets reduces the likelihood of damage from the magnet coupled to the drive shaft physically contacting and/or damaging the yoke and/or yoke magnets. In various specific embodiments, the polarity of the magnet is divided on an angle. Applicant believes using a magnet with angled poles provides for smoother, less noisy movement of the cutting blade because there is a less harsh transition between the poles of the magnet.

For ease of discussion and understanding, the following detailed description will refer to and illustrate the blade assembly that incorporates magnetic drive assembly with a hair cutting device or hair trimmer. It should be appreciated that a hair trimmer is provided for purposes of illustration, and the drive assembly disclosed herein can be used in association with any hair cutting, hair trimming, or hair grooming device. Accordingly, the term hair cutting device is inclusive, and refers to any hair grooming device including, but not limited to, a hair trimmer, a hair clipper, or any other hair cutting or hair grooming device. The hair clipping device can be suitable for a human, animal, or any other living or inanimate object having hair.

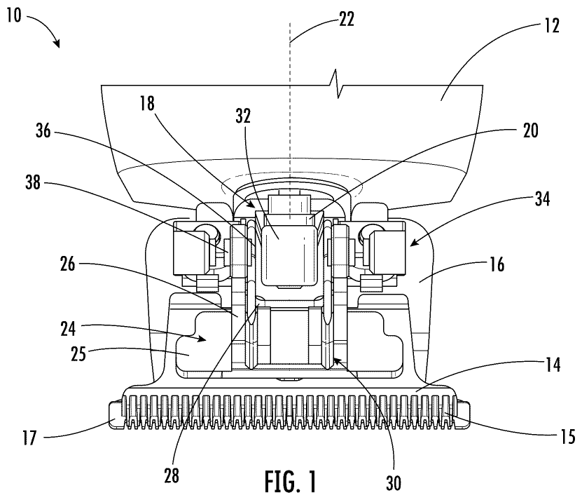

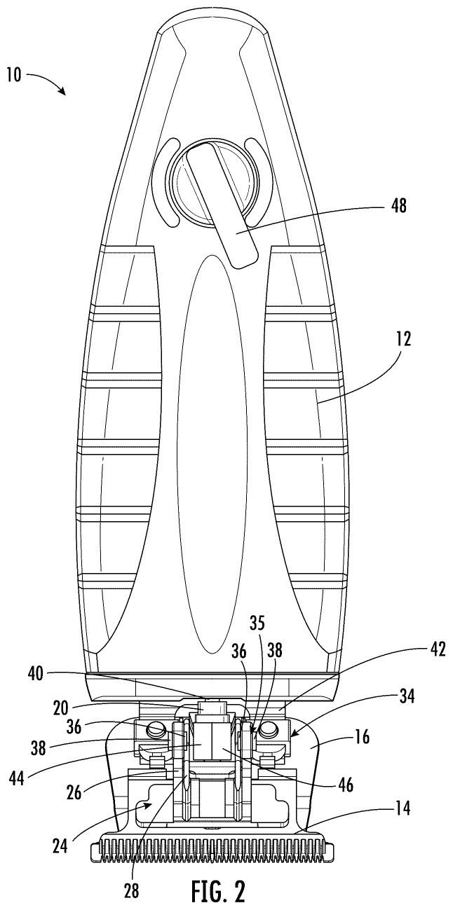

Referring to FIGS. 1-2, a detailed view of a hair cutting device, shown as a hair trimmer 10, is shown according to an exemplary embodiment. Hair trimmer 10 includes a body or handle 12 and a blade assembly 13. Blade assembly 13 includes a lower or stationary blade 16 and an upper or cutting blade 14 that moves or oscillates to cut hair. Cutting teeth 15 of cutting blade 14 move or oscillate over stationary blade 16. Cutting blade 14 has teeth 15 extending from along a blade edge and stationary blade 16 has teeth 17. Cutting blade 14 is supported relative to stationary blade 16 with cutting teeth 15 extending in the same orientation as teeth 17 on stationary blade 16. In other words, as cutting blade 14 oscillates over stationary blade 16, the teeth 15 on cutting blade 14 and stationary blade 16 capture hair follicles and cooperate to cut hair.

A drive assembly 18 is coupled to blade assembly 13. Drive assembly 18 includes a drive mechanism, such as magnet 32, a connector 20 and a yoke 24. The yoke 24 includes a body 25 that extends across an upper surface of cutting blade 14. A first side wall 26 and a second side wall 26 project upward, and/or rearward from the body 25 of yoke 24 and extend toward handle 12 and/or connector 20.

As will be discussed in greater detail below, drive assembly 18 is a magnetic drive assembly that reduces friction specifically by eliminating the eccentric drive contact with the yoke 24. In a specific embodiment, a magnet 32 is coupled to connector 20. In a specific embodiment, magnet 32 is a rare earth magnet. In a specific embodiment, magnet 32 is N52 neodymium. In various other embodiments, magnet 32 is a strong miniature magnet. Magnet 32 extends around a circumference of connector 20. In such a specific embodiment, magnet 32 is a ring magnet. In other embodiments, magnet 32 may have a different shape. The magnet 32 is positioned coaxially with the drive shaft 40. In such an embodiment the magnet 32 is diametrically polarized. In various embodiments, magnet 32 is not exactly coaxial (i.e., position is plus or minus 0.5 cm from coaxial). As will be generally understood, if the magnet 32 is not in a coaxial position, a larger motor is required and the effectiveness of magnet 32 may be reduced. In other words, when magnet 32 is coaxial with drive shaft 40, magnet 32 is in the most efficient configuration.

In various embodiments, magnet 32 has a first pole 44 and a second pole 46. In such an embodiment, the magnet 32 or poles are divided in an orientation parallel to axis of rotation 22. In a specific embodiment, first pole 44 is a positive pole and second pole 46 is a negative pole. In other embodiments, the first pole 44 can be a negative pole and the second pole 46 is a positive pole. In other words, when magnet 32 is stationary, the first pole 44 of magnet 32 is positioned on one side of the axis of rotation 22 and second pole 46 is positioned on an opposing side of axis of rotation 22. It should be appreciated that specific polarity is discussed for purposes of illustration of the drive assembly 18, and the drive assembly 18 disclosed herein can similarly be used in an orientation where the poles of the magnets are reversed.

One or more yoke magnets 35 are coupled to yoke 24 and more specifically first side wall 26 and second side wall 26. Each of the one or more yoke magnets 35 has a first pole 36 and a second pole 38. In a specific embodiment, the first pole 36 is a negative pole 38 and second pole 38 is a positive pole. In other embodiments, the first pole 36 can be a positive pole and the second pole 38 is a negative pole. In a specific embodiment, magnet 35 is a rare earth magnet. In a specific embodiment, magnet 35 is N52 neodymium. In various other embodiments, magnet 35 is a strong miniature magnet.

Yoke 24 is disposed above cutting blade 14 (from the perspective of FIG. 2). Yoke 24 and/or magnet 32 convert motion such as rotational motion of drive shaft 40 into reciprocation of cutting blade 14 with respect to lower, stationary blade 16.

In specific embodiments, yoke 24 also includes channels or grooves 30 defined within opposite sides of the body. In such an embodiment, channels 30 engage ends of spring 28. The ends of spring 28 apply a downward (from the perspective of FIG. 2) biasing force on cutting blade 14. In other words, spring 28 provides a tensioning force between cutting blade 14 and lower blade 16. In other embodiments, magnetic tensioning may be used instead of spring 28. Applicant believes magnetic tensioning of blade assembly 13 further reduces friction specifically by eliminating the spring end interaction with the yoke 24.

Hair trimmer 10 further includes a retainer 34 that is couplable to lower, stationary blade 16. In a specific embodiment, retainer 34 includes openings configured to receive housing connectors, shown as legs 42 that can be coupled to and/or fastened to retainer 34 and/or lower blade 16. Legs 42 extend downward toward blade assembly 13.

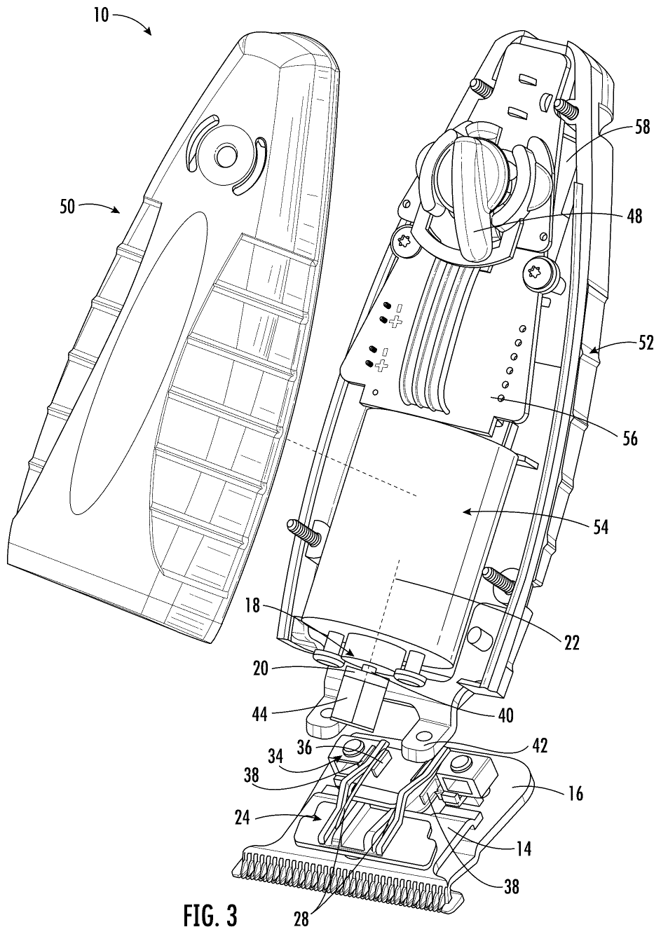

In various specific embodiments, handle 12 includes an upper housing 50 and a lower housing 52 (see e.g., FIG. 3). In various embodiments, handle 12 is a single, continuous, and/or integral part, such that upper housing 50 and lower housing 52 are permanently joined and/or fabricated as an integral continuous component or unitary part. In other embodiments, upper housing 50 is fabricated separately from lower housing 52 and joined or coupled to form handle 12, e.g., using fasteners.

Referring to FIG. 3, blade assembly 13 is positioned at an end of hair trimmer 10. A motor 54 is positioned near the end of lower housing 52 near blade assembly 13 and is offset by a counterweight provided by an internally housed power source. In various embodiments, the power source is an electrical storage device and/or a battery 58 at an opposing gripping end of handle 12. Motor 54 and battery 58 are housed within an internal cavity of handle 12.

A switch, shown as power switch 48 is connected to a power assembly that is configured to selectively distribute power (e.g., electricity, etc.) to the motor 54. The power assembly includes various components (e.g., electrical switch, a controller, etc.) to allow for electrical communication between the motor 54, battery 58 and drive assembly 18. The controller shown as printed circuit board assembly (PCBA) 56 is coupled to lower housing 52. The controller 56 is in electrical communication with the power source 58.

The motor 54 includes a drive shaft 40 that rotates around (or with respect to) axis of rotation 22. The connector 20 is couplable to the drive shaft 40 and magnet 32. The connector 20 can include an internal channel 92 (not shown) that is configured to receive the drive shaft 40. The connector 20 is configured to rotate as the drive shaft 40 rotates with respect to the axis of rotation 22. Connector 20 is configured to receive and/or couple to magnet 32 which engages the yoke 24 to translate or oscillate cutting blade 14 linearly or side-to-side relative to stationary blade 16.

In a specific embodiment, motor 54 is a rotary DC electric motor. In other embodiments, motor 54 is a pivot motor or a magnetic motor that generates oscillating or reciprocating movement for blade assembly 13. In various embodiments, motor 54 is a linear motor with an arm to generate the reciprocating driving force. In other embodiments, motor 54 is an AC electric motor or any other suitable motor for generating oscillating or reciprocating movement for a blade assembly 13. As illustrated, motor 54 is configured to operate on battery power (e.g., cordless), but may be configured to operate with electricity from any suitable electric source, (e.g., a hair clipper plugged into an outlet, etc.).

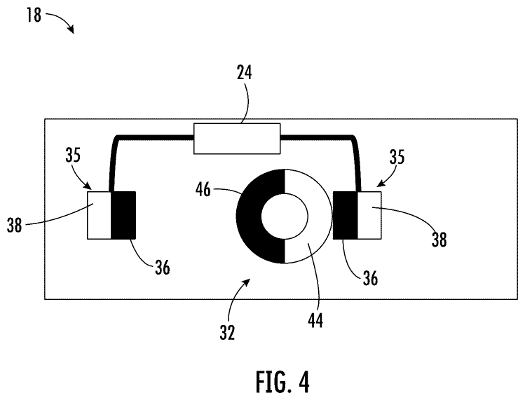

Referring to FIG. 4, a schematic diagram of the drive assembly 18 is shown according to an exemplary embodiment. The difference between the poles of the respective magnets is shown schematically. As shown in FIG. 4, when first pole 44 of magnet 32 is positioned adjacent to first pole 36 of yoke magnet 35 of yoke 24, because first pole 44 of magnet 32 and first pole 36 of yoke magnet are unalike there is an attractive force. The attractive force pulls yoke 24 from a generally centered or middle position relative to handle 12 to a side. Similarly, because the second yoke magnet 35 has first pole 36 that is like the second pole 46 of magnet 32 a repulsive force is created. The attractive force and repulsive force of drive assembly 18 together create a driving force to move yoke 24 and cutting blade 14 linearly or side-to side relative to handle 12. In other words, the driving force generates linear movement of yoke 24 relative to drive shaft 40.

When drive shaft 40 rotates the connector 20 and/or magnet 32 so that the first pole 44 of magnet 32 is positioned adjacent to first pole 36 of the second yoke magnet 35 in FIG. 4, there will now be an attractive force pulling magnet 32 toward the second yoke magnet 35 and a repulsive force between second pole 46 and first yoke magnet 35. In use, because the magnet 32 rotates, the yoke 24 and cutting blade 14 will move or be translated linearly along lower, stationary blade 16. In other words, magnet 32 acts as an eccentric drive.

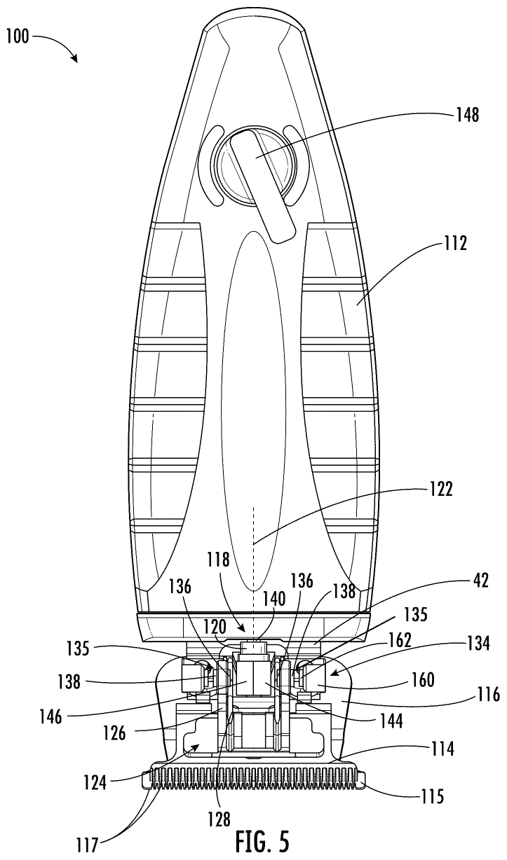

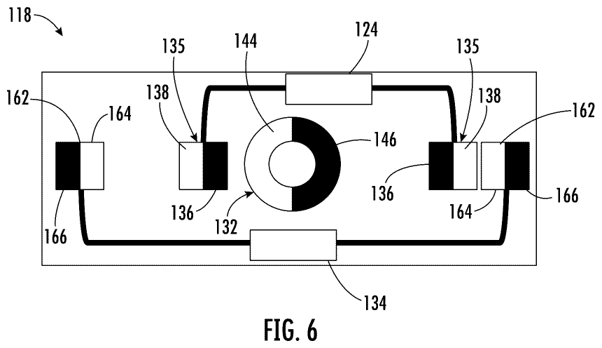

Referring to FIGS. 5-6, another embodiment of a driving assembly 118 that can be utilized with a hair cutting device such as hair trimmer 10 is shown according to an exemplary embodiment. Driving assembly 118 and hair trimmer 100 are substantially the same as driving assembly 18 and hair trimmer 10 except for the differences discussed herein.

Retainer 134 includes a first projection 160 and a second projection 160 on an opposing side of retainer 134 from the first projection 160. Each of the projections 160 extends and faces toward a side wall 126 of yoke 124. A first end magnet 162 is positioned on the first projection 160 and a second end magnet 162 is positioned on the second projection 160. The first and second end magnets 162 generate a controlling force to limit the movement of yoke 124 relative to the connector 120 and magnet 132. In various specific embodiments, retainer 134 is an integral component with hair trimmer 100 and/or housing 112. In various embodiments, a spring or other dampening component can be used instead of magnets. Applicant believes the controlling force reduces the likelihood of unwanted impact between magnet 132 and the yoke 124 that might otherwise damage the drive assembly 118.

Referring to FIG. 6, a schematic diagram of the drive assembly 118 is shown according to an exemplary embodiment. As shown in FIG. 6, the attraction and repulsion between the yoke magnets 135 and the magnetic 132 coupled to the connector 120 is the same as drive assembly 18. The first and second end magnets 162 each include a first pole 164 and a second pole 166.

Because first pole 164 of the first end magnet 162 and second pole 138 of yoke magnet 135 are alike there is repulsive force that stops the movement of yoke 124 in the direction of first end magnet 162 despite the attractive force between first pole 144 of magnet 132 that pulls yoke 124 from a generally centered or middle position relative to handle 12. When magnet 132 is rotated, the pull changes direction toward the second yoke magnet 135 and the opposing end magnet 162. Similarly, because the second yoke magnet 135 has second pole 138 that is like the first pole 164 of the second end magnet 162 a repulsive force is created preventing yoke 124 and cutting blade 111 from moving farther than desired. While the attractive force and repulsive force of drive assembly 118 still creates a driving force to move yoke 124 and cutting blade 114, the controlling force generated by end magnets 162 provides a resistance against the linear movement of yoke 124 once the yoke 124 is adjacent to end magnets 162.

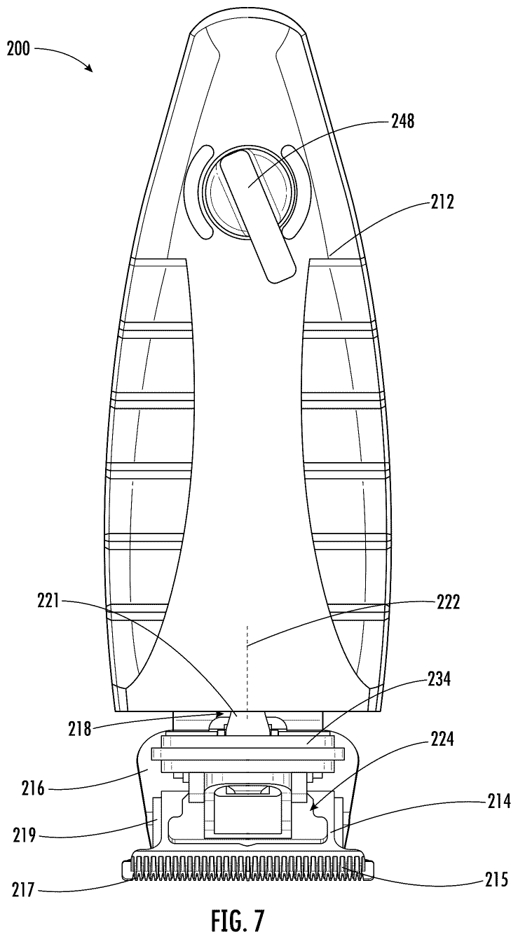

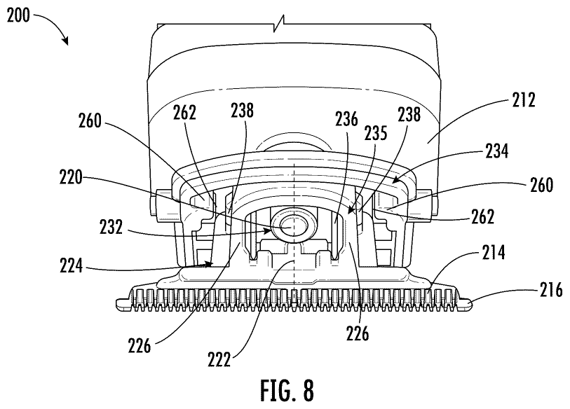

Referring to FIGS. 7-8, another embodiment of a driving assembly 218 that can be utilized with a hair cutting device such as hair trimmers 10, 100 is shown according to an exemplary embodiment. Driving assembly 218 and hair trimmer 200 are substantially the same as drive assemblies 18, 118 and hair trimmers 10, 100 except for the differences discussed herein. Yoke 224 includes opposing side walls 126 that extend around the front (in the perspective shown in FIG. 7) of connector 221 and at least partially surrounds magnet 232. As noted above, magnetic blade tensioning can be used in addition to having a magnetic drive assembly instead of using springs. Applicant has found use of a magnetic tensioning assembly rather than a spring reduces noise caused by the vibration of the spring.

Yoke 224 is fixedly coupled to cutting blade 214 and receives motor (e.g., 54) output through the magnetic drive assembly 218 and specifically due to connector 221 and magnet 232. In various specific embodiments, magnet 232 is a disc magnet, such as a solid disc magnet. In other embodiments, magnet 232 is one of a block magnet and a ring magnet. When the haircutter 200 is assembled, the magnet 232 is positioned coaxially with the drive shaft. In various embodiments, magnet 232 is not exactly coaxial (i.e., position is plus or minus 0.5 cm from coaxial). As will be generally understood, if the magnet 232 is not in a coaxial position, a larger motor is required and the effectiveness of magnet 232 may be reduced. In other words, when magnet 232 is coaxial with the drive shaft, magnet 232 is in the most efficient configuration. In various embodiments, the magnet 232 is diametrically polarized. The movement of the drive assembly 218 causes cutting blade 214 to oscillate over stationary blade 216.

Applicant believes the structure and/or shapes of yoke 224 and retainer 234 provides stiffness, improved fatigue resistance and reduce post molding warping that potentially alters the dimensions of yoke 224 and/or retainer 234. In a specific embodiment, the side walls of yoke 224 have an L-shaped cross-section and are connected by a U-shaped wall to provide additional stiffness. In a specific embodiment, retainer 234 has a ring shape. In other words, when blade assembly 213 is assembled, retainer 234 extends around and encloses or surrounds yoke 224, connector 221, and/or magnet 232. In a specific embodiment, retainer 234 has a T-shaped cross section to provide increased stiffness.

As will be generally understood, magnet 232 corresponds to magnets 32, 132, magnet 235 corresponds to magnets 35, 135 and magnet 262 corresponds to magnet 162 (see e.g., FIGS. 4 and 6). Therefore, the engagement between magnets 232 and magnets 235, 262 is substantially the same as what is shown and described in FIGS. 4 and 6 respectively.

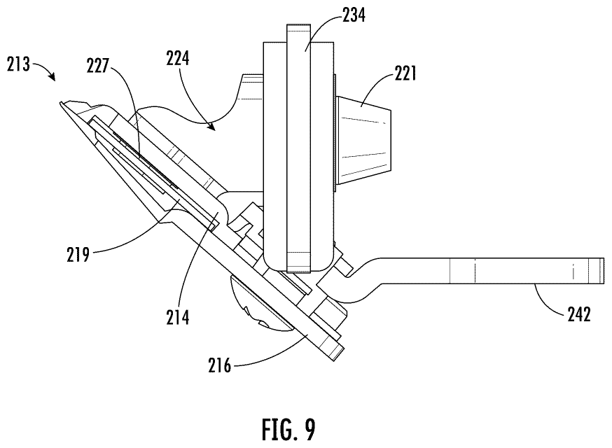

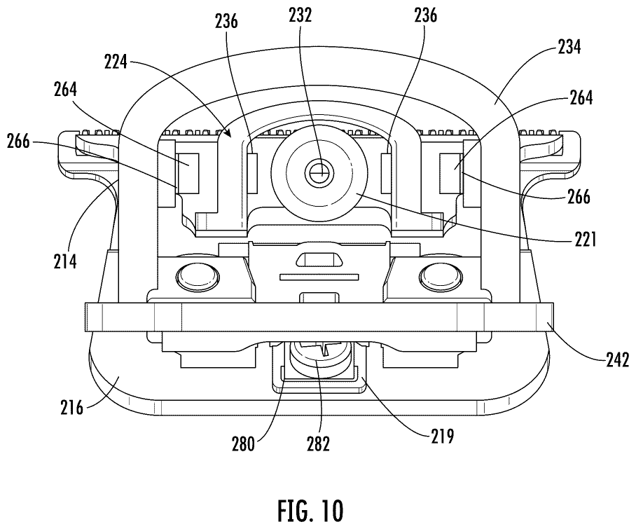

Referring to FIGS. 9-11, a guide member 219 is mounted to the stationary blade 219 and includes a guide base or arm 278 and a cross-portion 276. In a specific embodiment, the blade assembly 213 further includes a washer 280 including a pair of slots or openings extending parallel to the major axis of the guide arm 278 and perpendicular to the major axis of the cross-portion 276 that can be coupled to the guide member 219 using fasteners 282 (e.g., screws). In a specific embodiment, arm 278 is planar (i.e., flat.

The cross-portion 276 includes a guide edge parallel to the cutting blade 214 edge and/or the stationary blade 216 edge when the guide member 219 is installed on the stationary blade 216. The guide member 219 guides the reciprocating movement of the cutting blade 214 with the guide edge. In a specific embodiment, guide member 219 is T-Shaped. A pair of fastener holes permit fasteners 282 (e.g., screws) to pass through stationary blade 216 and fixedly couple stationary blade 216 to a blade assembly housing or handle 212 of a hair cutting device 200.

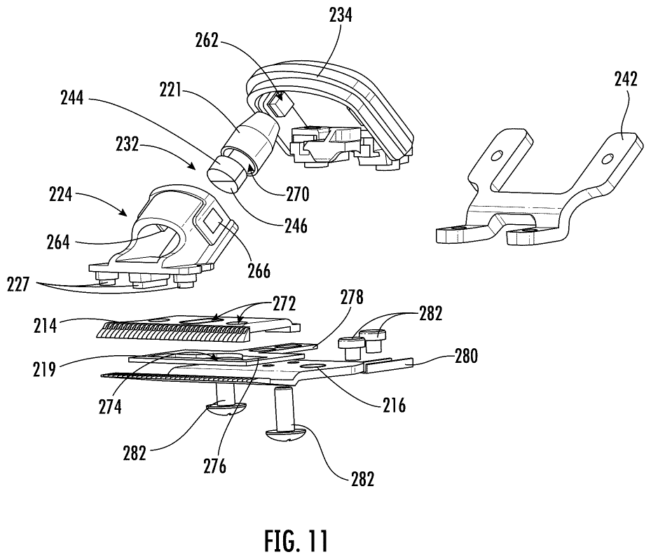

Referring to FIG. 9, a side view of the blade assembly 213 is shown, according to an exemplary embodiment. Yoke 224 includes a body or cross-portion extending in a generally parallel orientation to the cutter blade edge. Blade assembly 213 includes a magnetized ferromagnetic material and/or at least one magnet 227 positioned between yoke 224 and stationary blade 216. For example, in some embodiments yoke 224 is a non-conductive magnet carrier (e.g., a plastic yoke 224 carrying a magnet 227) or conductive magnetic material. In a specific embodiment, at least one magnet 227 is positioned within and/or coupled to yoke 224. In a specific embodiment a pair of magnets 227 are coupled to yoke 224. In another specific embodiment, three magnets 227 are coupled to yoke 224. Magnets 227 extend through the cutting blade 214 and specifically bores 272 (see e.g., FIG. 11) toward stationary blade 216. In a specific embodiment, magnets 227 are rare earth magnets. In a specific embodiment, the magnets are formed from Neodymium. In such an embodiment, the Neodymium has a grade of N52.

Magnet 227 includes a lower surface that faces an upper surface of stationary blade 216. In a specific embodiment, a gap or space 229 is defined between the lower surface of magnet 227 and the upper surface of stationary blade 216. Applicant believes the tensioning force produced reduces friction and/or wear when gap 229 has a dimension or length D. In a specific embodiment, D is between 0.005 and 0.02 inches and more specifically between 0.01 and 0.015 inches.

Referring to FIG. 11, an exploded view of the blade assembly 213 is shown, according to an exemplary embodiment. The cross-portion 276 of guide member 219 includes an opening 274 extending through guide member 219. When the blade assembly 213 is assembled a portion of a magnetic tensioning assembly such as one or more magnets 227 are positioned within and/or extend through the opening 274.

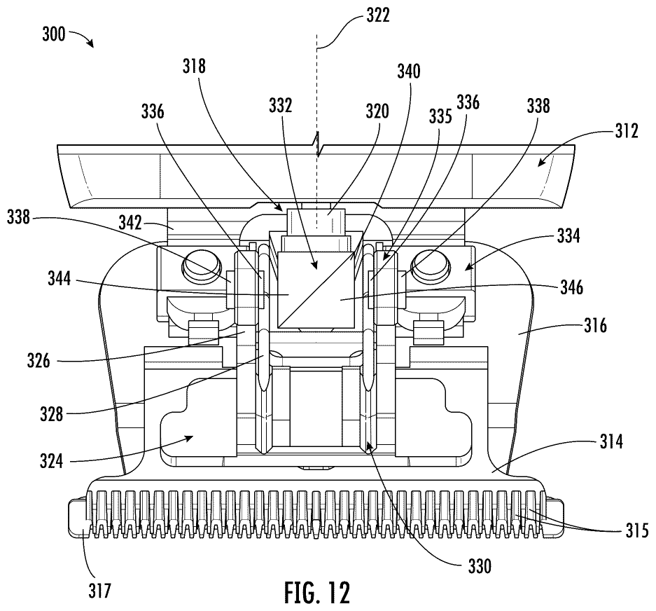

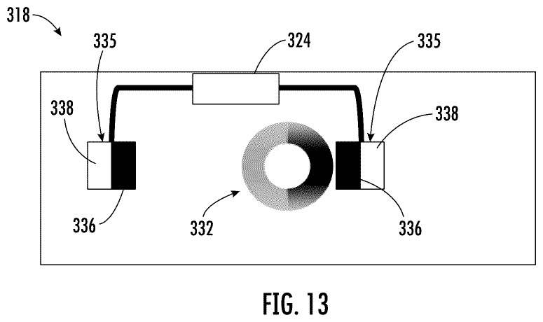

Referring to FIGS. 12-13 another embodiment of a driving assembly 318 that can be utilized with a hair cutting device such as hair trimmers 10, 100, 200 is shown according to an exemplary embodiment. Driving assembly 318 and hair trimmer 300 are substantially the same as driving assembly 18 and hair trimmer 10 except for the differences discussed herein.

The magnet 332 coupled to connector 320 has poles with a different shape. Instead of being split along the longitudinal axis of handle 312 or rotational axis 322, a first pole 344 and second pole 346 are angled relative to the longitudinal or rotational axis 322. Therefore, both the first pole 344 and the second pole 346 are positioned on both sides of the longitudinal axis or rotational axis 322 when magnet 332 is stationary or rotating. In other words, a pole boundary 340 between the first pole 344 and the second pole 346 is angled relative to the rotational axis 322 such that the first pole 344 and the second pole 346 are each positioned on both sides of the rotational axis 322.

Applicant believes using a magnet 332 with angled polarization provides for a smoother, less noisy movement of the cutting blade 314 because there is a less abrupt transition between the poles 344, 346 of the magnet 332. The transition between poles is shown schematically as a gradient on magnet 332. Applicant has found the cutting stroke of hair trimmer 300 with an angled magnet 332 provides a more consistent linear movement of cutting blade 314 and/or cutting stroke.

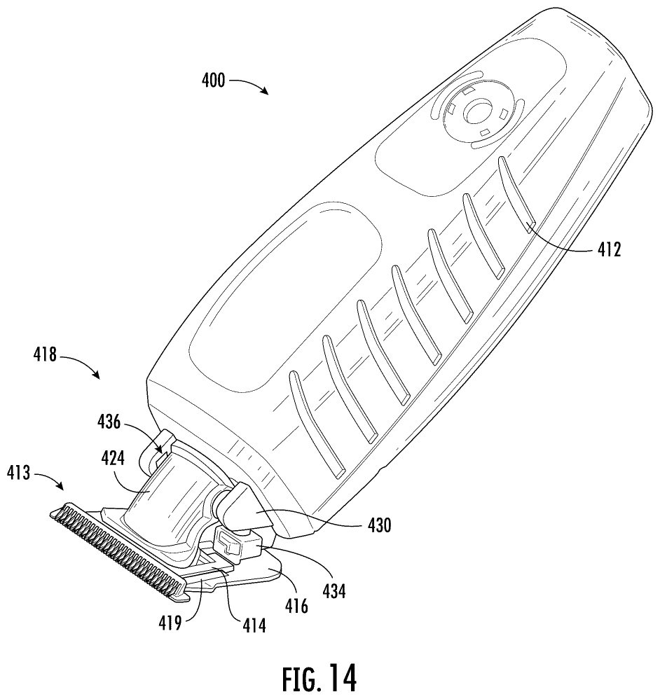

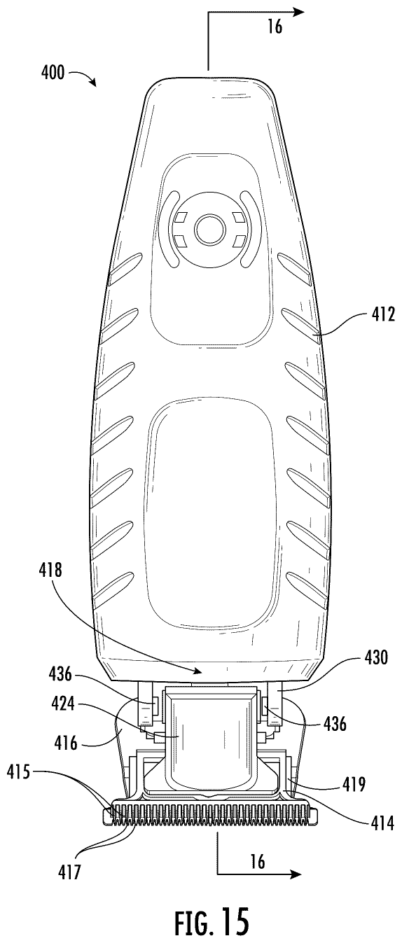

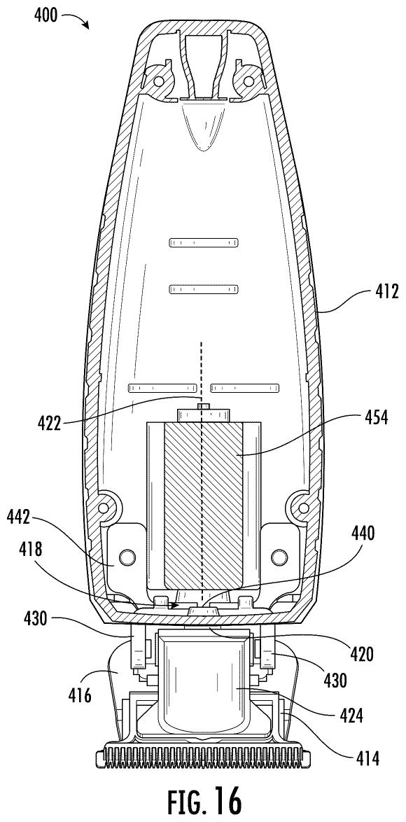

Referring to FIGS. 14-16 another embodiment of a driving assembly 418 that can be utilized with a hair cutting device such as hair trimmers 10, 100, 200, 300 is shown according to an exemplary embodiment. Driving assembly 418 and hair trimmer 400 are substantially the same as driving assembly 18, 118, 218, 318 and hair trimmer 10, 100, 200, 300 except for the differences discussed herein.

Drive assembly 418 is a magnetic drive assembly that reduces friction specifically by eliminating the eccentric drive contact with the yoke (see e.g., 24, 124, 224, etc.). In contrast to drive assemblies previously discussed, drive assembly 418 includes a bracket, shown as removable bracket 424. When hair trimmer 400 is assembled, removable bracket 424 is coupled to cutting blade 414, bracket or retainer 430, and/or connector 420. In various embodiments, retainer 430 is fixedly coupled to handle 412. In other words, retainer 430 is not easily removed from trimmer 400 without disassembly.

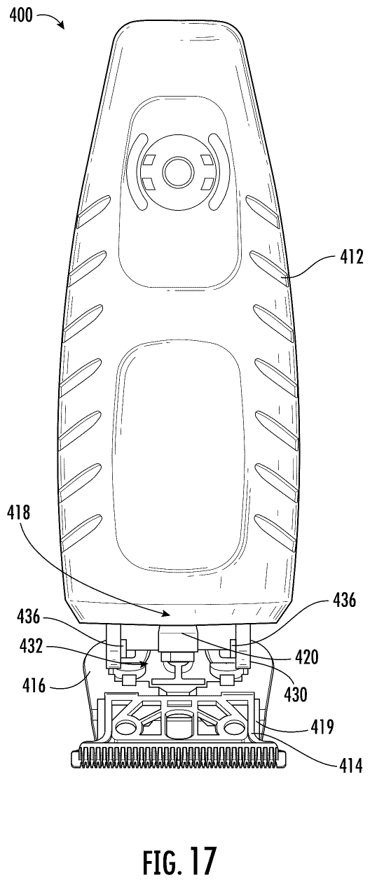

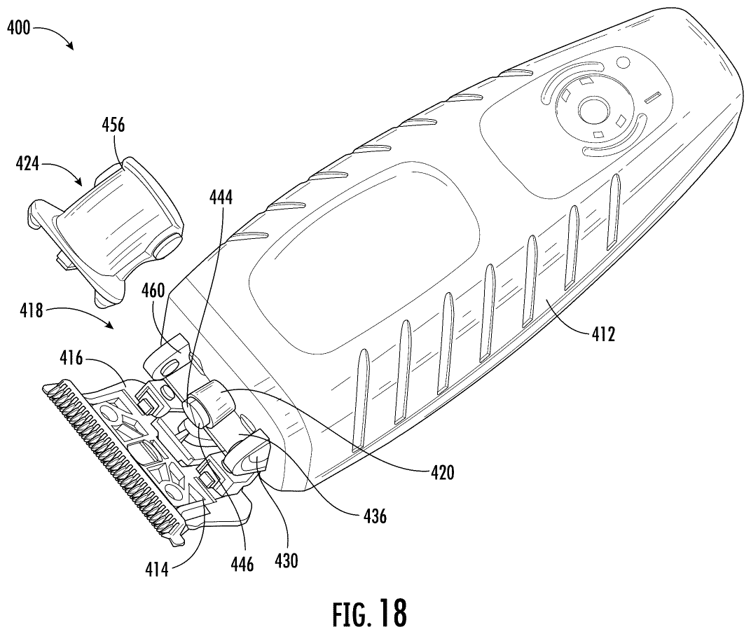

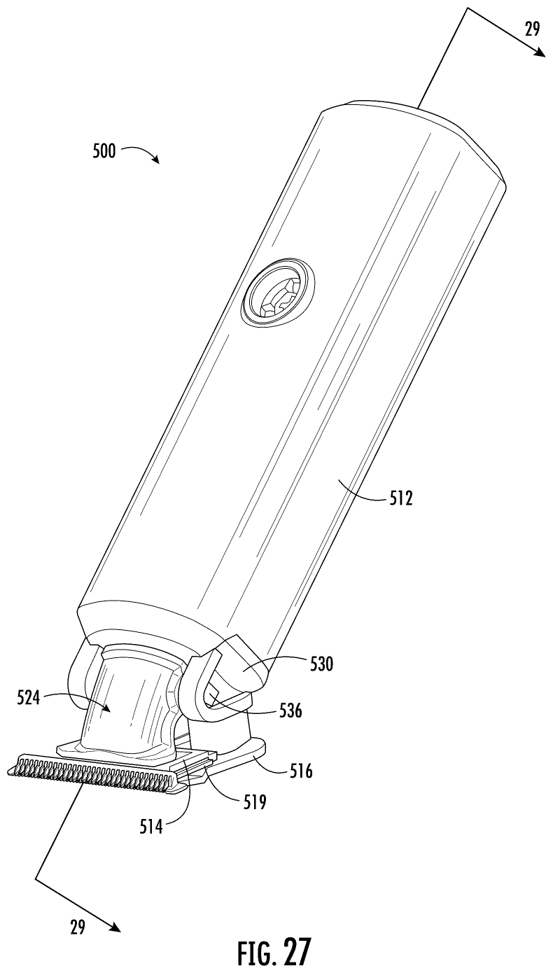

As shown in FIGS. 17-18, removable bracket 424 can be easily and quickly pulled out of place from drive assembly 418. In various specific embodiments, removable bracket 424 is magnetically coupled to cutting blade 414, retainer 430, and/or connector 420. Unlike previous drive assembly embodiments discussed herein, removable bracket 424 allow for protection of drive assembly 418 components while allowing for easy access. Applicant believes the use of the end magnets reduces the likelihood of damage from the magnet coupled to the drive shaft physically contacting and/or damaging the removable bracket 424 or yoke. In various other embodiments, bracket 424 fully encloses the drive shaft 440. In other words, in such embodiments drive shaft 440 is sealed (i.e., waterproof, etc., see e.g., FIGS. 27-29) to prevent debris from interfering with drive assembly 418.

Drive assembly 418 has substantially the same magnetic arrangement as drive assembly 218 (see e.g., FIG. 6) except for the position of the magnets.

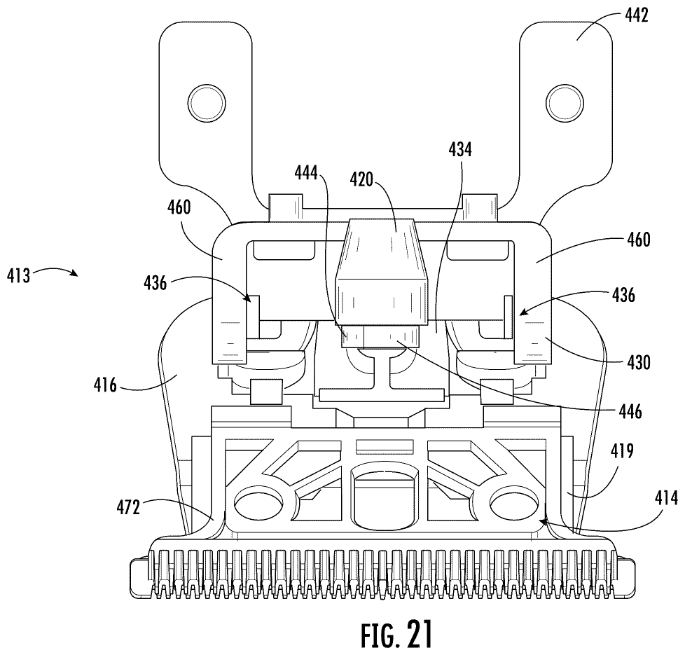

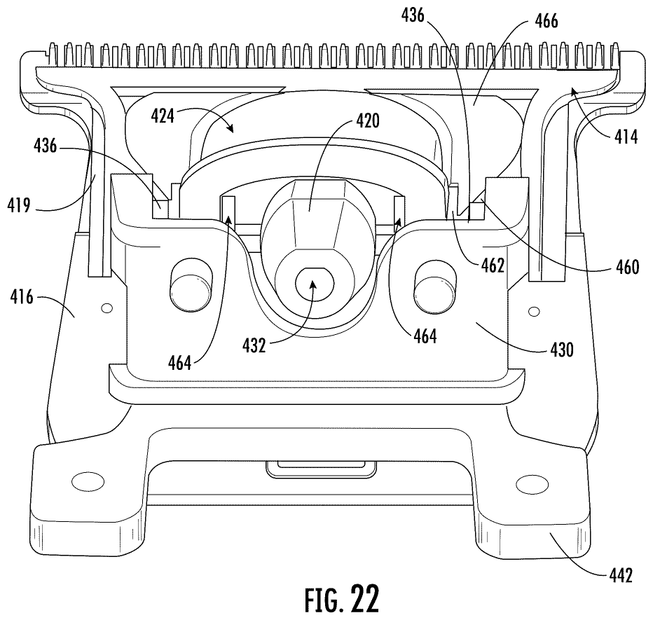

Referring to FIGS. 18 and 21-22, retainer 430 includes opposing walls 460 on opposing side of retainer 430. Each of the opposing walls 460 faces toward removable bracket 424 when drive assembly is fully assembled or coupled to hair trimmer 400. Otherwise, opposing walls 460 face toward connector 420 and magnet, shown as drive magnet 432. A first end magnet 436 is positioned on a first wall 460 and a second end magnet 436 is positioned on the second wall 460. The first and second end magnets 436 generate a controlling force to limit the movement of removable bracket 424 relative to the connector 420 and magnet 432. In other words, the controlling force provides a resistance against linear movement of bracket 424. Applicant believes the controlling force reduces the likelihood of unwanted impact between magnet 432 and the removable bracket 424 that might otherwise damage the drive assembly 418.

The attraction and repulsion between the bracket magnets 464 and the magnet 432 coupled to the connector 420 is the same as drive assembly 18, 118. The first and second end magnets 436 each include a first pole and a second pole.

Because first pole 164 of the first end magnet 426 and second pole of removable bracket magnet 464 are alike there is repulsive force that stops the movement of bracket 424 in the direction of first end magnet 436 despite the attractive force between first pole 444 of magnet 432 that pulls yoke 324 from a generally centered or middle position relative to handle 412. When magnet 432 is rotated, the pull changes direction toward the second yoke magnet 135 and the opposing end magnet 162. Similarly, because the second bracket magnet 464 has a second pole that is like the first pole of the second end magnet 436 a repulsive force is created preventing bracket 424 and cutting blade 414 from moving farther than desired. While the attractive force and repulsive force of drive assembly 418 still creates a driving force to move bracket 424 and cutting blade 414, the controlling force generated by end magnets 436 provides a resistance against the linear movement of bracket 424 once the bracket 424 is adjacent to end magnets 436. In other words, the driving force generates linear movement bracket 424 relative to the drive shaft.

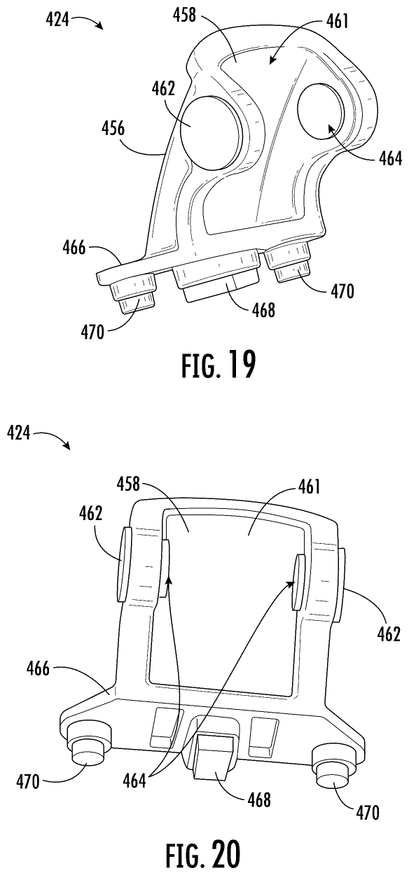

Referring to FIGS. 19-20, details of removable bracket 424 are shown according to an exemplary embodiment. Removable bracket 424 includes an outer surface 456 and an inner surface 458 that defines a cavity or space 461. Opposing sides of inner surface 458 include opposing bracket magnets 464 facing each other. When removable bracket 424 is coupled to trimmer 400, bracket magnets 464 are positioned on opposing sides of connector 420 and magnet 432. Opposing sides of outer surface 456 include dampers, shown as damping pads 462. Applicant believes use of damping pads 462 on the outer surface of removable bracket 424 reduces vibrations and therefore noise within drive assembly 418.

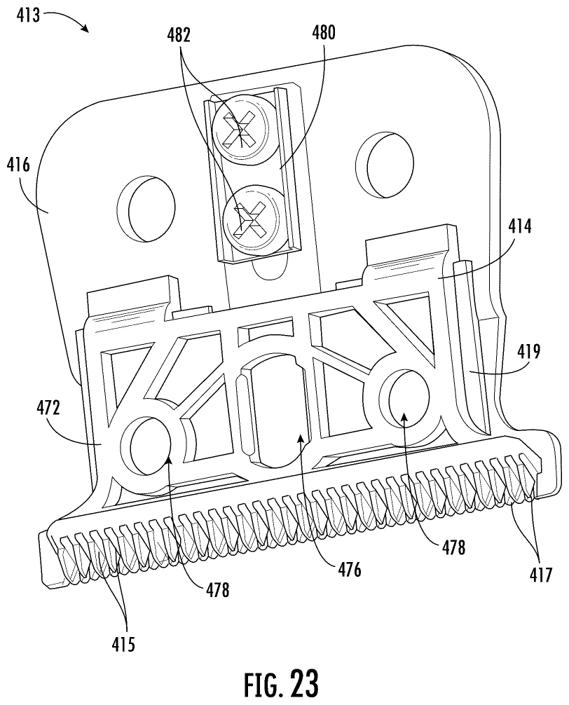

Removable bracket 424 further includes a cross-portion 466 similar to yoke 24, 224. In a specific embodiment, at least one magnet 470 is positioned within and/or coupled to removable bracket 424 and specifically cross-portion 466. In a specific embodiment a pair of magnets 470 are coupled to removable bracket 424. In another specific embodiment, three magnets 470, 468 are coupled to removable bracket 424. Magnets 470, 468 extend through the cutting blade 414 and specifically bores 476, 748 (see e.g., FIG. 23) toward stationary blade 416. In a specific embodiment, magnets 470, 468 are rare earth magnets. In a specific embodiment, the magnets are formed from Neodymium. In such an embodiment, the Neodymium has a grade of N52.

In various specific embodiments, removable bracket 424 and/or cross-portion 466 include three magnets with a pair of magnets 470 positioned on opposing sides of a middle or central magnet 468. In other words, in such embodiments, central magnet 468 is between two side magnets 470.

Magnets 270, 468 includes a lower surface that faces an upper surface of stationary blade 416. In a specific embodiment, a gap or space is defined between the lower surface of magnets 470, 468 and the upper surface of stationary blade 416. Applicant believes the tensioning force produced reduces friction and/or wear when gap has a specific dimension or length. In a specific embodiment, the dimension is between 0.005 and 0.02 inches and more specifically between 0.01 and 0.015 inches.

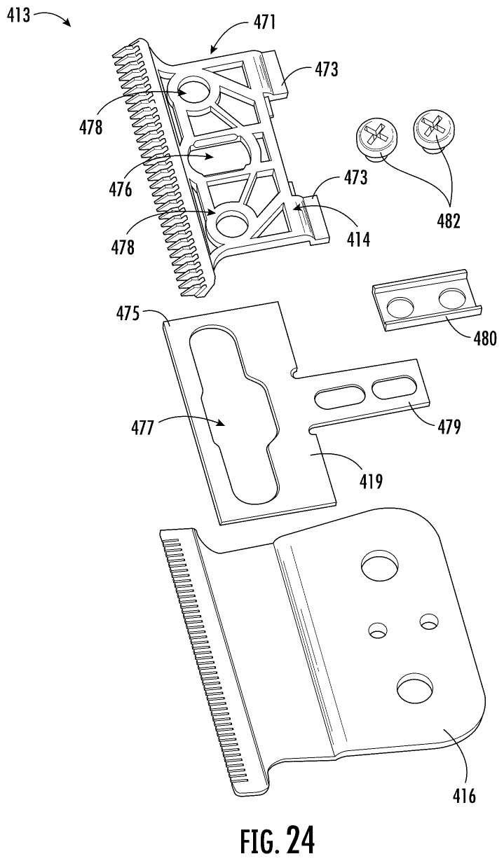

Referring to FIGS. 23-24 details of blade assembly 413 are shown according to an exemplary embodiment. Blade assembly 413 can be utilized with trimmer 10, 100, 200, 300. In contrast to conventional blade assemblies, blade assembly 413 utilizes a cutting blade 414 with less mass than a typical cutting blade. As can be seen in FIG. 24, cutting blade 414 is hollowed out such that the mass will be less than a solid cutting blade. In various embodiments, the mass of cutting blade 414 is reduced 25% relative to a conventional cutting blade.

Applicant believes the reduced cutting blade 414 mass allows for a better stroke of cutting blade 414 and therefore improved cutting performance of trimmer 400. As will generally be understood, a cutting blade 414 with less mass requires less force to move allowing more acceleration. In various specific embodiments, motor 454 is a brushless motor. Applicant has found use of a brushless motor 454 reduces noise because the motor is able to get up to speed more quickly.

In various specific embodiments, cutting blade 414 is formed from a ______material. In various embodiments, cutting blade 414 with the reduced mass if formed using metal injection molding. In various specific embodiments, cutting blade 414 is formed using 3D printing.

Blade assembly 413 includes a guide member 419 that is mounted to the stationary blade 416 and includes a guide base or arm 479 and a cross-portion 475. In a specific embodiment, the blade assembly 413 further includes a washer 480 including a pair of slots or openings extending parallel to the major axis of the guide arm 479 and perpendicular to the major axis of the cross-portion 475 that can be coupled to the guide member 419 using fasteners 482 (e.g., screws). In a specific embodiment, arm 479 is planar (i.e., flat). In various specific embodiments, cross-portion 475 includes a bore 477. When blade assembly is assembled, magnets 470, 468 coupled to removable bracket 424 extend through guide member 419 and bore 477.

The cross-portion 475 includes a guide edge parallel to the cutting blade 414 edge and/or the stationary blade 416 edge when the guide member 419 is installed on the stationary blade 416. The guide member 419 guides the reciprocating movement of the cutting blade 414 with the guide edge. In a specific embodiment, guide member 419 is T-Shaped. A pair of fastener holes permit fasteners 282 (e.g., screws) to pass through stationary blade 416 and fixedly couple stationary blade 416 to a blade assembly housing or handle 412 of hair cutting device 400.

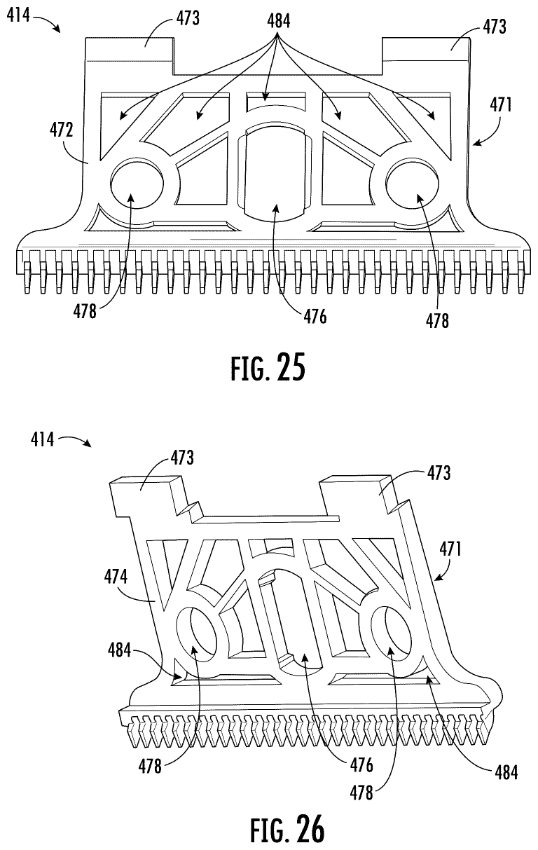

Referring to FIGS. 25-26, details of cutting blade 414 are shown according to an exemplary embodiment. Cutting blade 414 includes a body 471 with an upper or upward facing surface 472 and an opposing lower or downward facing surface 474. As previously discussed, body 471 includes one or more bores 476, 478 that extend from upper surface 472 to lower surface 474. Bores 476, 478 receive the one or more magnets 470, 468 coupled to removable bracket 424.

Cutting blade 414 further includes one or more additional bores 484 positioned in various locations around body 471 of cutting blade 414. As noted above, additional bores 484 remove material from blade 414 such that the mass of cutting blade 414 is reduced compared to conventional cutting blades. In various specific embodiments, additional bores 484 are positioned between magnet bores 478, 476 and feet 473 of cutting blade 414. Feet 473 are located on a rear edge of cutting blade 414. In various specific embodiments, additional bores 484 are positioned between magnet bores 478, 476 and the blade edge and/or cutting teeth 415.

Referring to FIGS. 27-29, another embodiment of a driving assembly that can be utilized with a hair cutting device such as hair trimmers 10, 100, 200, 300, 400 is shown according to an exemplary embodiment. Hair cutting device 500 is substantially the same as hair devices 10, 100, 200, 300, 400 except for the differences discussed herein.

Drive assembly 518 is substantially the same as drive assemblies 18, 118, 218 and 418. In other words, drive magnet 532 corresponds to magnet 32 (see e.g., FIGS. 1 and 4). As will be generally understood, magnet 532 corresponds to magnets 32, 132, 232, 432. Drive magnet 232 engages magnets on removable bracket 524 and bracket 530 in the same manner previously discussed (see e.g., FIGS. 4 and 6).

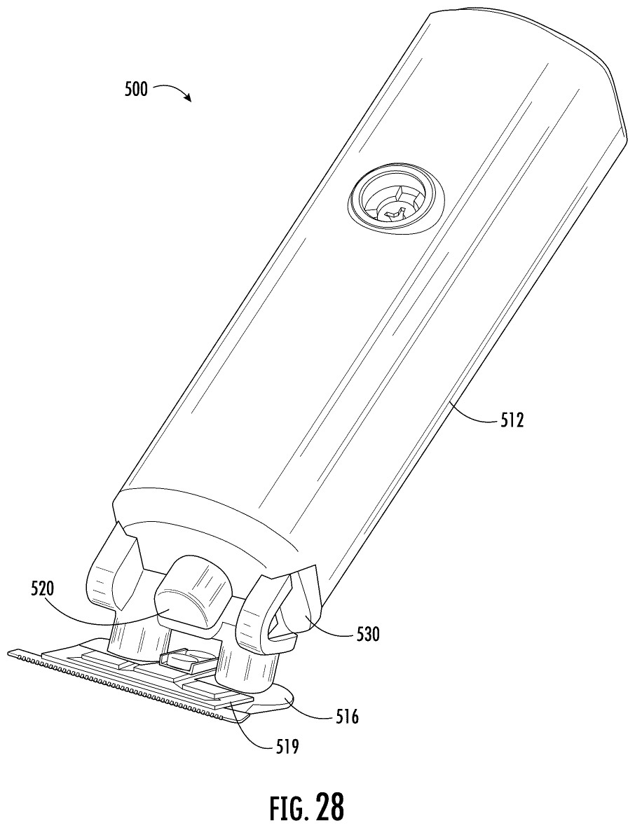

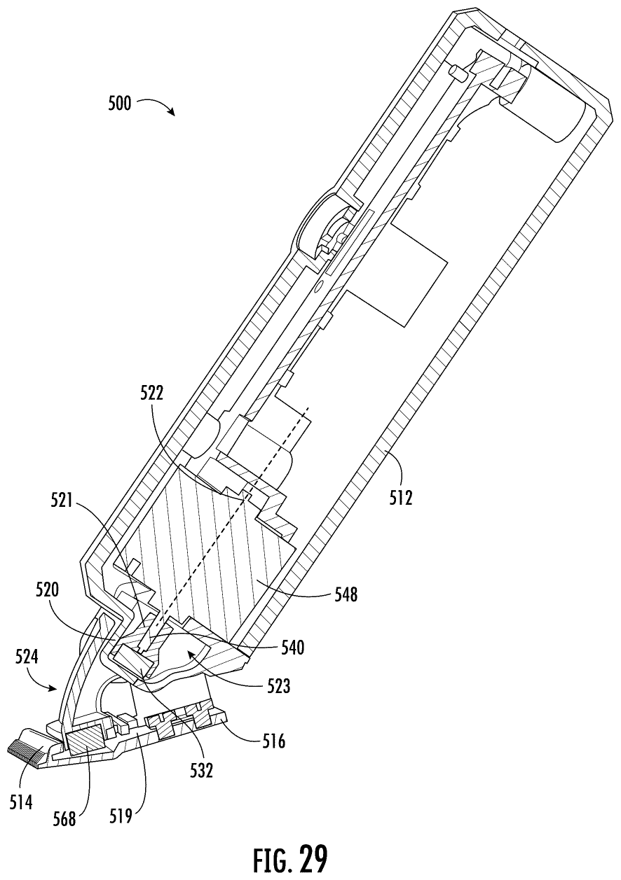

As shown in FIGS. 28-29, drive shaft 540 is entirely enclosed or sealed to prevent debris from interfering with drive assembly 518. As will be generally understood, hair, debris, metal shavings from wearing blades may be released toward drive assembly 518 and handle 512 over time. The enclosed or surrounded position of drive shaft 540 prevents unwanted interaction between such debris and drive assembly 518 and/or magnet 532. As shown in FIG. 27, when hair cutting device 500 is assembled, removable bracket 524 is coupled to cutting blade 514. As can be seen in FIG. 28, with removable bracket 524 disengaged from handle 512, drive shaft 540 and/or the drive assembly is enclosed within hair cutting device 500 and more specifically within an interior of handle 512.

A bracket or retainer 530 is coupled to handle 512. In various specific embodiments, bracket 530 is integral with handle 512. A middle or central portion 520 of bracket 530 encloses an end of handle 512 and defines an internal cavity 523. Connector 521 is coupled to drive shaft 540 and positioned within cavity 523. Connector 521 supports and/or receives a drive magnet 523. In such an embodiment, drive magnet 523 is enclosed within central portion 520 of bracket 530 and/or handle 512.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description. In addition, in various embodiments, the present disclosure extends to a variety of ranges (e.g., plus or minus 30%, 20%, or 10%) around any of the absolute or relative dimensions disclosed herein or determinable from the Figures.

What is claimed is:

1. A haircutter, comprising:
a housing extending along a longitudinal axis;
a motor positioned within the housing;
a power source, the power source configured to selectively distribute energy to the motor;
a drive assembly, the drive assembly comprising:
a drive shaft coupled to the motor;
a bracket comprising:
a body comprising:
a first side wall; and
a second side wall, the first side wall and the second side wall positioned on opposing sides of the drive shaft;
a first magnet positioned on the first side wall; and
a second magnet positioned on the second side wall; and
a drive magnet coupled to the drive shaft, wherein the drive magnet generates a driving force;
a blade assembly, the blade assembly comprising:
a stationary lower blade; and
an upper blade supported relative to the stationary lower blade, the upper blade coupled to the drive assembly, wherein the drive assembly uses the energy from the power source to move the drive magnet relative to the bracket such that the upper blade moves over the stationary lower blade.

2. The haircutter of claim 1, wherein the drive magnet is in a coaxial position relative to the drive shaft.

3. The haircutter of claim 1, the drive magnet further comprising a first pole and a second pole, wherein, when the drive magnet is stationary, the first pole is positioned on a side of the longitudinal axis and the second pole is positioned on an opposing side of the longitudinal axis.

4. The haircutter of claim 2, the drive magnet further comprising a first pole positioned adjacent to the first magnet and a second pole is positioned adjacent to the second magnet.

5. The haircutter of claim 3, wherein the driving force further comprises an attractive force between the first pole and the first magnet and a repulsive force between the second pole and the second magnet such that the blade assembly moves in a direction of the attractive force.

6. The haircutter of claim 5, wherein, when the drive shaft rotates, the first pole is positioned adjacent to the second magnet and the second pole is positioned adjacent the first magnet.

7. The haircutter of claim 6, wherein the driving force further comprises an attractive force between the first pole and the second magnet and a repulsive force between the second pole and the first magnet.

8. The haircutter of claim 1, further comprising:
a retainer coupled to the housing, the retainer at least partially surrounds the bracket.

9. The haircutter of claim 8, the retainer further comprising:
a first surface;
a second surface, the first and the second surface facing toward the first side wall and the second side wall of the bracket respectively;
a first end magnet positioned on the first surface; and
a second end magnet positioned on the second surface;
wherein the first end magnet and the second end magnet generate a controlling force to limit movement of the bracket relative to the drive magnet.

10. The haircutter of claim 1, the drive magnet further comprising a first pole and a second pole, wherein, when the drive magnet is stationary, the first pole and the second pole are angled relative to the longitudinal axis such that the first pole and the second pole are each positioned on both sides of the longitudinal axis.

11. A magnetic drive assembly for a haircutter, the magnetic drive assembly comprising:
a drive shaft positioned along an axis of rotation;
a bracket comprising:
a body comprising:
a first side wall; and
a second side wall, the first side wall and the second side wall positioned on opposing sides of the drive shaft;
a first magnet positioned on the first side wall; and
a second magnet positioned on the second side wall; and
a drive magnet coupled to the drive shaft, wherein the drive magnet generates a driving force to move the bracket.

12. The magnetic drive assembly of claim 11, the drive magnet further comprising a first pole and a second pole, wherein, when the drive magnet is in a first position, the first pole is positioned on a side of the axis of rotation and the second pole is positioned on an opposing side of the axis of rotation.

13. The magnetic drive assembly of claim 12, wherein, when the drive magnet is in the first position, the driving force further comprises an attractive force between the first pole and the first magnet and a repulsive force between the second pole and the second magnet such that the bracket moves in a first direction toward the attractive force.

14. The magnetic drive assembly of claim 13, wherein, when the drive shaft rotates the drive magnet into a second position, the first pole is positioned adjacent to the second magnet and the second pole is positioned adjacent the first magnet such that driving force comprises an attractive force between the first pole and the second magnet and a repulsive force between the second pole and the first magnet, and wherein the bracket moves in a second direction that is opposite the first direction.

15. The magnetic drive assembly of claim 11, further comprising a retainer positioned behind the bracket, the retainer comprising:
a first surface positioned distal to the first side wall of the bracket;
a second surface positioned distal to the second side wall of the bracket;
a first end magnet positioned on the first surface and facing toward the first side wall of the bracket; and
a second end magnet positioned on the second surface and facing toward the second side wall of the bracket;
wherein the first end magnet and the second end magnet generate a controlling force to limit movement of the bracket relative to the magnet.

16. A magnetic drive assembly for a haircutter, the magnetic drive assembly comprising:
a drive shaft extending along an axis of rotation;
a bracket comprising:
a body comprising:
a first side wall; and
a second side wall, the first side wall and the second side wall positioned on opposing sides of the drive shaft;
a first magnet positioned on the first side wall; and
a second magnet positioned on the second side wall;
a drive magnet coupled to the drive shaft, wherein the drive magnet generates a driving force to move the bracket; and
a retainer, the retainer comprising:
a first end magnet facing the first magnet; and
a second end magnet facing the second magnet.

17. The magnetic drive assembly of claim 16, wherein the driving force generates linear movement of the bracket relative to the drive shaft.

18. The magnetic drive assembly of claim 17, wherein the first end magnet and the second end magnet generate a controlling force to provide resistance against the linear movement of the bracket.

19. The magnetic drive assembly of claim 16, wherein the drive magnet is a disc magnet that is diametrically polarized.

20. The magnetic drive assembly of claim 16, wherein the drive magnet is coaxial with the drive shaft.
